(19) United States
(12) Patent Application Publication
(10) Pub. No.: US 2024/0118067 A1
(43) Pub. Date: Apr. 11, 2024

(54) MEASURING TAPE WITH END HOOK HAVING A LASER ETCHED HIGH FRICTION SURFACE

(71) Applicant: Apex Brands, Inc., Apex, NC (US)

(72) Inventor: Miles Cawley, Charlotte, NC (US)

(21) Appl. No.: 18/481,663

(22) Filed: Oct. 5, 2023

Related U.S. Application Data
(60) Provisional application No. 63/414,712, filed on Oct. 10, 2022.

(51) Int. Cl. G01B 3/1056

(52) U.S. Cl. CPC G01B 3/1056; G01B 2003/1058

(57) ABSTRACT

A measuring tape device may include a housing which may have an aperture, a reel assembly, a blade which may have a first end that may extend from the housing through the aperture and a second end wound on the reel assembly, and an end hook which may be disposed at the first end of the blade. The end hook may have a front face that faces away from the aperture and a rear face that faces toward the aperture. A high friction surface comprising laser etching may be disposed over at least a portion of a surface of the rear face.

### TECHNICAL FIELD

Example embodiments generally relate to measuring tape devices, and particularly relate to a measuring tape that has an end hook configured to avoid slippage relative to many different types of surfaces.

### BACKGROUND

Measuring tapes have been around for a very long time, and are common measuring tools used in numerous contexts to obtain linear measurements. Measuring tapes can come in many forms and may be made of cloth, fiber glass, metal, plastic, or the like. The materials used are often dictated by the specific measuring application. For example, tailors and dressmakers typically use a flexible tape that can be easily manipulated between two hands to measure a distance therebetween. However, for construction or carpentry applications, a stiff and often metallic tape is preferred to allow the measuring tape to be extended between an a first location at which one end of the tape is anchored, and the location of the user at whose location the measuring tape is paid out from a reel assembly. The reel assembly may have a manual retracting mechanism or a self-retracting mechanism, typically depending upon the length of the measuring tape. For relatively short measuring tapes (e.g., 12 ft or 25 ft), self-retracting mechanisms are very common. For very long measuring tapes (e.g., larger than 100 ft), a manual retracting mechanism is typically employed.

For nearly a century, metallic tape ribbons with a curved and relatively stiff construction have been preferred for use in self-retracting measuring tapes. The metallic tape ribbon tends to be flexible enough to permit the metallic tape ribbon to be wound onto a spring loaded reel assembly, but stiff enough to have a relatively long standout. By employing an end hook at one end of the tape, the user may take advantage of the standout to pay out the measuring tape toward an anchor point on a media that is to be measured and then conduct the measurement without having to physically move to the anchor point to affix the end hook and then move away to make the measurement. However, if the end hook is unable to be affixed remotely to the anchor point, the operator may ultimately have to physically place the end hook at the anchor point (perhaps after multiple attempts at doing it remotely). Even then, the end hook could slip off sometimes, leading to additional frustration for the operator. Thus, having an end hook that is less likely to slip off, and more likely to engage a medium being measured, can be very attractive to consumers.

### BRIEF SUMMARY OF SOME EXAMPLES

Some example embodiments may provide for a measuring tape device. The measuring tape device may include a housing which may have an aperture, a reel assembly, a blade which may have a first end that may extend from the housing through the aperture and a second end wound on the reel assembly, and an end hook which may be disposed at the first end of the blade. The end hook may have a front face that faces away from the aperture and a rear face that faces toward the aperture. A high friction surface comprising laser etching may be disposed over at least a portion of a surface of the rear face.

Some example embodiments may provide for an end hook for a measuring tape device. The end hook may include a front face that may face away from an aperture through which a blade of the measuring tape device may be extendible, a rear face that may face toward the aperture, and a high friction surface which may include laser etching disposed over at least a portion of a surface of the rear face.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a measuring tape device in accordance with an example embodiment;

FIG. 2 illustrates a block diagram of the measuring tape device in accordance with an example embodiment;

FIG. 3A illustrates a top side perspective view of an end hook having a high friction surface in accordance with an example embodiment;

FIG. 3B illustrates a bottom side perspective view of an end hook having a high friction surface in accordance with an example embodiment;

FIG. 3C illustrates a rear view of an end hook having a high friction surface in accordance with an example embodiment;

FIG. 4 illustrates a diagram of a laser etching process in accordance with an example embodiment;

FIG. 5A illustrates a high friction surface with a dimple pattern in accordance with an example embodiment;

FIG. 5B illustrates a high friction surface with a linear pattern in accordance with an example embodiment;

FIG. 6 illustrates a profile view of the high friction surface after the laser etching process according to an example embodiment; and

FIG. 7 illustrates flowchart diagram of a method of making a measuring tape device according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of a measuring tape device that may have an improved end hook. To improve the gripping ability of the measuring tape device, some end hooks may have protrusions aimed backward toward the anchor point. These rear facing (i.e., facing in a direction substantially parallel to the direction of extension of the blade of the tape measure, and substantially perpendicular to the direction of extension of the end hook) protrusions are provided to dig into soft materials (such as wood) to decrease the likelihood of slippage of the end hook off the soft material to which the end hook is attempted to be anchored. Thus, the protrusions can create a much greater amount of gripping capability or friction with soft materials. However, for hard materials, and particularly for hard materials with a smooth surface (such as steel or other metals), these protrusions may drastically decrease the contact surface area between the end hook and the material to which the end hook is being anchored, and slippage may actually become much more likely. This effectively makes a measuring tape with protrusions on the end hook virtually unusable, or at least much less desirable for use, for a rather large number of contexts. The corresponding measuring tape is then essentially specialized only for one use (i.e., use with wood or other soft materials).

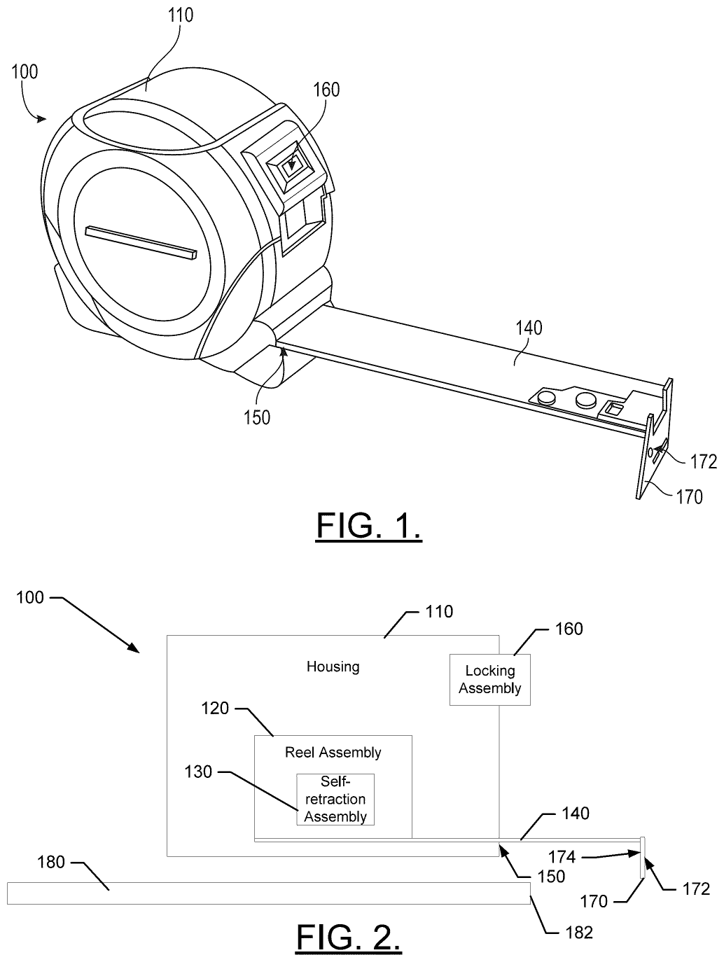

Example embodiments are directed to providing an end hook that can effectively balance the desire to increase friction with the need to avoid too much loss of contact surface area so that such an end hook can be reliably anchored on a variety of surfaces without slippage. Other efforts have been made to accomplish this, and such efforts include the addition of a high friction surface on the end hook by adding granules of hard materials that can be affixed to a surface of the end hook with a silicon carbide coating. While effective for the primary purpose, these solutions are relatively expensive, and complicated to produce. Some example embodiments therefore use a high friction surface comprising a laser etched pattern provided on a rear facing surface of the end hook to increase friction, but provide the laser etched pattern over a larger area of the rear facing surface of the end hook to also increase the contact area between the high friction surface of the end hook and the material to which the end hook is to be anchored. The material that has been laser etched on the end hook may, for example, create a multitude of three dimensional patterns that can effectively increase the friction between the end hook and both hard and soft materials to which the end hook may be anchored in various different contexts. Thus, the resulting tape measure employing such an end hook can be advantageously employed in every context and need not be specialized only to use with specific limited types of materials. Moreover, employing this method of forming a high friction surface on the end hook is both cheaper and simpler than prior methods. The resulting device may therefore be more easily produced, and have improved cost efficiency (e.g., with an end hook up to five times cheaper). FIG. 1 illustrates a perspective view of a measuring tape device, and FIG. 2 illustrates a block diagram of such device, in accordance with an example embodiment.

Referring now to FIGS. 1 and 2, a measuring tape device 100 of an example embodiment may include a housing 110 inside which a reel assembly 120 and a self-retraction assembly 130 may be provided. A blade 140 (or tape) portion of the device 100 may be wound onto the reel assembly 120. The blade 140 may be paid out through an aperture 150 formed in the housing 110. Although not required, in some cases, a locking assembly 160 may be provided to enable the reel assembly 120 to be locked to prevent the self-retraction assembly 130 from retracting the blade 140 when the locking assembly 160 is engaged.

The blade 140 has an end hook 170 disposed at a first end thereof, and is affixed to the reel assembly 120 at a second end of the blade 140. The end hook 170 may include a side surface 171, a front face 172 that faces away from the direction of extension of the blade 140 and a rear face 174 that faces toward the blade 140 and the aperture 150. The rear face 174 and the front face 172 may lie in planes that are substantially parallel to each other, and substantially perpendicular to a direction of extension of the blade 140 when the blade 140 is paid out of the aperture 150. The side surface 171 may extend between the front face 172 and the rear face 174, and may extend entirely around a perimeter of the end hook 170. In this regard, the side surface 171 may be one long continuous surface between the front face 172 and the rear face 174.

The end hook 170 may be affixed (temporarily) to a medium 180 that is to be measured at an anchor point 182. When affixed to the anchor point 182, the rear face 174 generally faces the medium 180 and/or engages a surface of the medium 180 while the front face 172 is on an opposing side of the end hook 170 relative to the medium 180 and faces away from the medium 180. Once the end hook 170 is affixed to the anchor point 182, the blade 140 may be paid out of the aperture 150 and unwound from the reel assembly 120. During this pay out of the blade 140, the rear face 174 of the end hook 170 may grip and therefore retain engagement with the medium 180 at the anchor point 182. The amount of friction between the rear face 174 and the surface of the medium 180 that is engaged thereto may determine how well the end hook 170 grips and retains engagement with the medium 180. When a desired length of the blade 140 has been paid out, the user can make any necessary markings, readings, etc., associated with measuring scale markings that may be printed on the blade 140. The measuring scale markings generally measure length from the end hook 170 in one or more units, with divisions and subdivisions of such units clearly marked on the blade 140.

By fixing the end hook 170 to the anchor point 182, the self-retraction assembly 130 (which may be spring loaded in some cases) may be prevented from retracting the paid out portions of the blade 140 into the housing 110 (via the aperture 150). Similarly, when the locking assembly 160 is engaged, a force (e.g., a pinching force) may be placed on the blade 140 to prevent retraction or motion of the reel assembly 120 may otherwise be inhibited to prevent the self-retraction assembly 130 from retracting the paid out portions of the blade 140. However, when the end hook 170 is not anchored and the locking assembly 160 is not engaged, the self-retraction assembly 130 may cause the reel assembly 120 to wind the blade 140 back onto the reel assembly 120.

As mentioned above, for a typical measuring tape, when the blade 140 is paid out through the aperture 150, the blade 140 will extend relatively straight out the aperture 150 (although some sagging or droop may be noticed due to the weight of the blade 140). The blade 140 can be extended in a guided fashion toward an intended target anchor point (e.g., anchor point 182) while the blade 140 continues to have sufficient rigidity to standout. When the blade 140 has been extended to allow the end hook 170 to engage the anchor point 182, or when the operator manually places the end hook 170 at the anchor point 182, the blade 140 can be extended to perform any intended measurements so long as the end hook 170 remains fixed at the anchor point 182.

For a typical, flat piece of media that is being measured, the blade 140 (which generally has a shallow U-shaped cross section) lays across the medium 180 and the end hook 170 engages the anchor point 182 such that the medium 180 and the anchor point 182 are both below the blade 140 (or at least on the same side of the blade 140). However, it is possible that measurements may be desirable in other orientations for the blade 140 and the end hook 170. With other orientations, however, gravity may work to unseat the end hook 170 from the anchor point 182. To attempt to accommodate other orientations, the end hook 170 could, for example, be provided with an enhanced ability to grip the surface of the medium 180 being measured at the anchor point 182. The enhanced gripping capability may not only provide flexibility in terms of the orientations that can be supported by the end hook 170, but may also provide flexibility in terms of the different types of materials for which the end hook 170 may be enabled to effectively grip the anchor point 182.

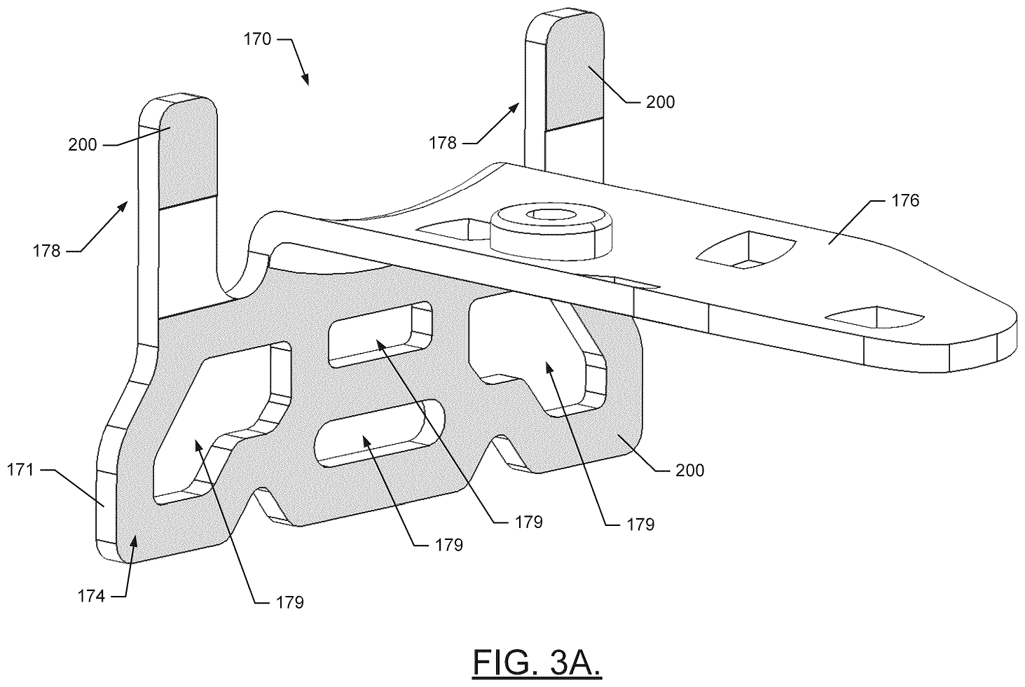

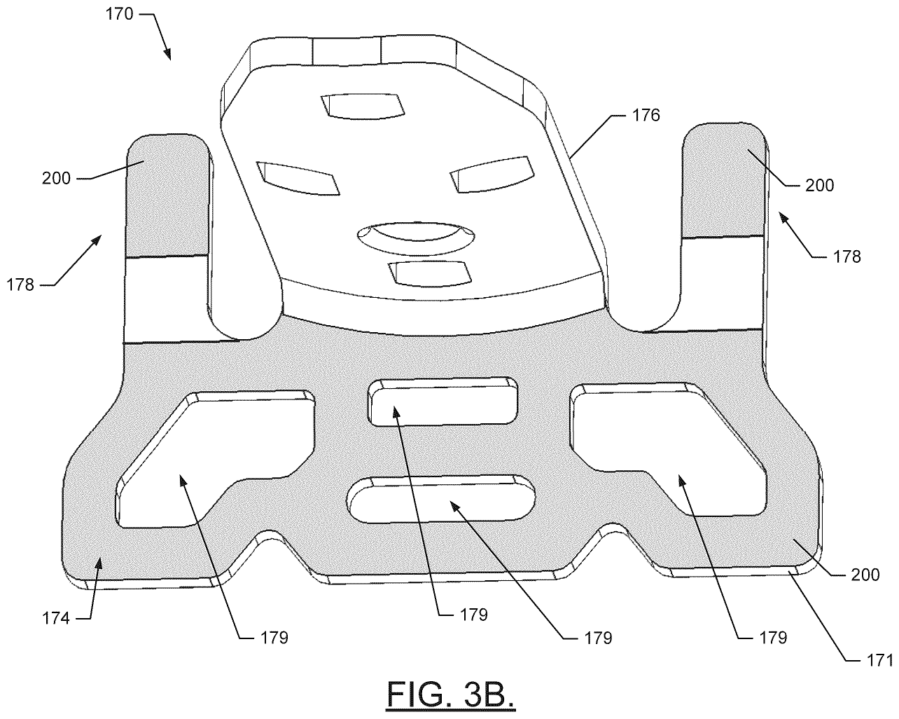

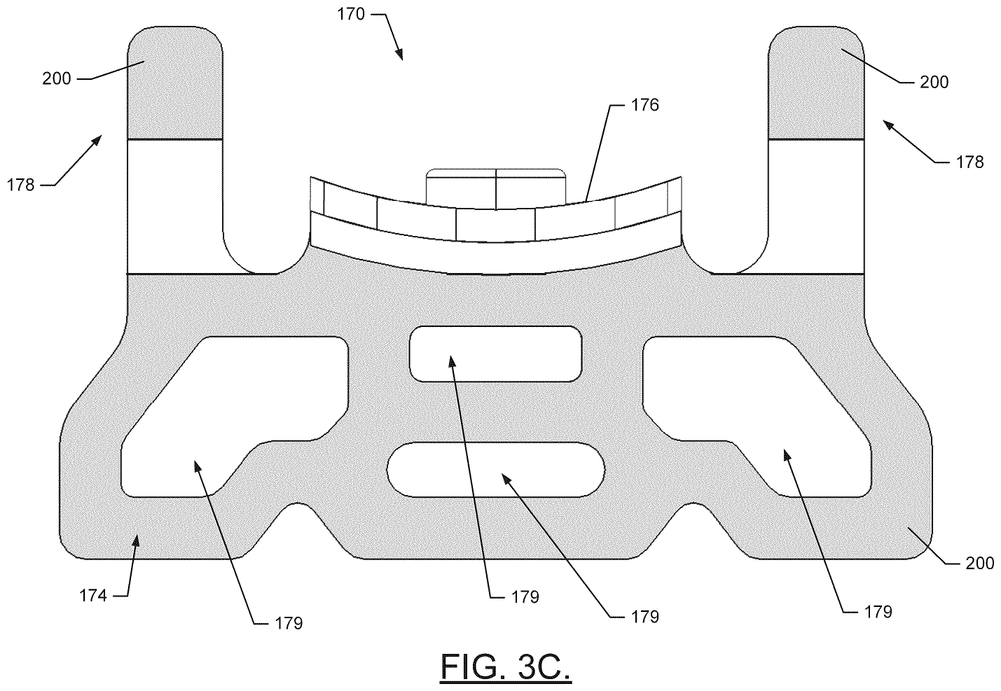

FIG. 3, which is defined by FIGS. 3A, 3B, and 3C, illustrates an example of an end hook 170 in accordance with an example embodiment. Referring to FIG. 3, the end hook 170 may further include a base portion 176 that extends substantially parallel to a surface of the blade 140 and is affixed thereto (e.g., via rivets or the like). The front face 172 and rear face 174 may each extend substantially perpendicular to the base portion 176. In some embodiments, the end hook 170 may also include one or more upright extension 178. The upright extension 178 may be formed from the same material as the rest of the end hook 170 and may extend on an opposite side of the blade 140 from the rear face 174, perpendicularly away from the blade 140. In this regard, the upright extension 178 could be used to affix the blade 140 to an anchor point 182 and the blade 140 may be paid out accordingly. Thus, in some cases, a high friction surface 200 may be disposed on the rear face 174 of the end hook 170 and the upright extension 178. In some embodiments, however, the rear face 174 only may be provided with the high friction surface 200. In some other embodiments, the upright extension 178 only may be provided with the high friction surface 200. In an example embodiment, the front face 172 may also be provided with the laser etched high friction surface 200 in addition to the rear face 174 and/or the upright extension 178.

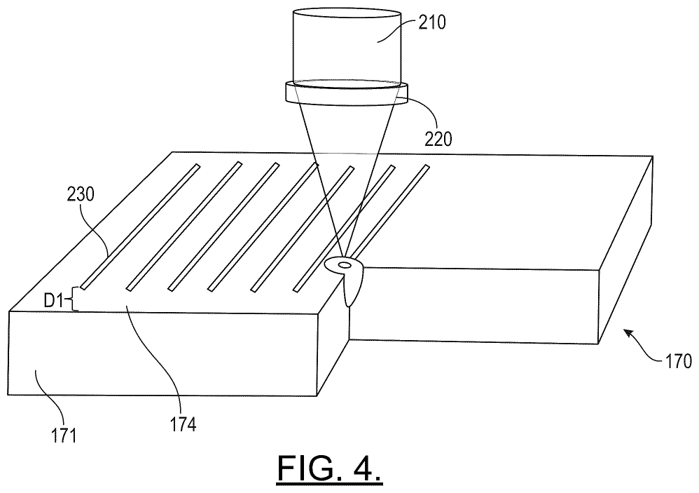

The high friction surface 200 may be provided over portions of the rear face 174, as shown by the darkened regions in FIGS. 3A, 3B and 3C. In some cases, however, the high friction surface 200 may be provided over substantially all of the rear face 174. In some other cases, the high friction surface 200 may be situated only on specific portions of the rear face 174. For example, the high friction surface 200 may be disposed on the rear face 174 such that edges of the high friction surface 200 are spaced apart from corresponding edges of the rear face 174 where the rear face 174 meets the side surface 171. In such an example, the edges of the high friction surface 200 may be equidistantly spaced apart from the bottom and side edges where the rear face 174 meets the side surface 171 as shown by distance D1 in FIG. 4, or in some embodiments, the edges may have different spacing therebetween. In some embodiments, edges of the high friction surface 200 may correspond to at least a portion (and sometimes all) of the edges of where the rear face 174 meets the side surface 171. In some cases, bottom edges of both the high friction surface 200 and the rear face 174 may be coextensive over their entire lengths and edges of the high friction surface 200 may be coextensive with edges of the rear face 174 over only a portion (in this case more than half) of the length of the edges of the rear face 174. This arrangement may advantageously provide a majority (e.g., over half) of the exposed surface area of the rear face 174 to be covered with the high friction surface 200 to maximize the amount of surface area that can grip the medium 180 at the anchor point 182. In some cases, the specific portion of the rear face 174 that may be covered with the high friction surface 200 may be a bottom portion. Thus, it may be more likely that the high friction surface 200 will come into contact with the medium 180 even if the rear face 174 is at a slight angle to the medium 180 instead of being parallel thereto when the operator attempts to anchor the end hook 170 at the anchor point.

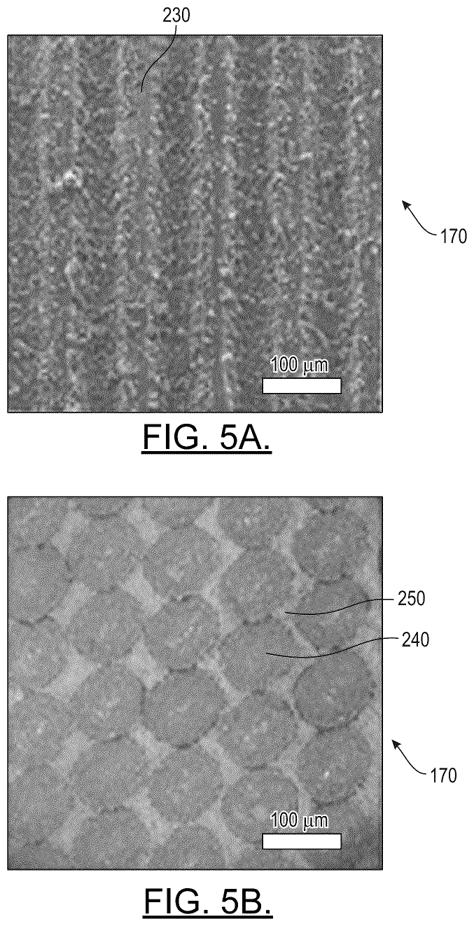

Both the end hook 170 and the high friction surface 200 may take a number of different shapes and forms. Thus, although FIGS. 3A-3C illustrate the end hook 170 according to one particular embodiment with the high friction surface 200 disposed on the rear face 174, other shapes are also possible for both the end hook 170 and the high friction surface 200. Moreover, in some cases, the high friction surface 200 could be embodied as a pattern of shapes as shown in FIGS. 5A and 5B. The various examples may increase a coefficient of friction of the rear face 174 of the end hook 170 relative to the medium 180.

FIG. 4 illustrates a diagram of a laser etching process showing the formation of the high friction surface 200 according to an example embodiment. As shown in FIG. 4, the high friction surface 200 may be laser etched into the rear face 174 of the end hook 170. In this regard, the end hook 170 may be subjected to rapid pulses of a high powered laser 210 that may be focused into a very fine interaction region by a lens 220. In the laser etching process, the laser 210 may ablate the material at the surface of the end hook 170 at the interaction region. In other words, at the surface of the end hook 170, the laser 210 may heat the material of the end hook 170 rapidly, causing the material to liquefy and pool up very briefly before evaporating or sublimating and thereby forming a melt pool. The result after the material evaporates is the removal of material from the end hook 170 in organized patterns of a plurality of melt pools. The amount of material that is removed by each individual pulse from the laser 210 may be a function of the material properties of the particular material, the wavelength of the light from the laser 210, and the duration of the pulse. By controlling these factors, the high friction surface 200 may be formed to include precise patterns, as described below in reference to later figures, etched onto the rear face 174 of the end hook 170.

The laser etched high friction surface 200 may provide various advantages over other non-slip solutions. For instance, the laser etching process may be more cost effective than applying a silicon carbide coating to the end hook 170. The laser etched high friction surface 200 may also resist wearing down through time and repeated use better than a coating applied to the end hook 170 might. Additionally, the laser etching process may provide more flexibility in where the high friction surface 200 is applied. In this regard, the rear face 174 may be substantially trapezoidal in shape such that a width of the end hook 170 may be greater than a width of the blade 140. Portions of the end hook 170 may thus extend outside the width of the blade 140 to provide an expanded surface area for engagement of at least the rear face 174 with an anchor point 182. In addition, the end hook 170 may include one or more cut-out portions 179 where material of the end hook 170 has been removed entirely. The cut-out portion 179 may improve the gripping ability of the end hook 170, and may reduce the weight of the end hook 170 as well. Accordingly, the laser 210 may be used to precisely etch the unique shape of the end hook 170 and achieve the most effective high friction surface 200 for the particular shape of the end hook 170, including etching the upright extension 178 and around the cut-out portion 179. Similarly, the side surface 171 of the end hook 170 may be left un-etched (i.e., smooth) so that the side surface 171 may be less likely to accidentally scratch the medium 180.

FIGS. 5A and 5B illustrate a few different examples of high friction surface 200 patterns that may be laser etched into the end hook 170. In some embodiments, such as the one depicted in FIG. 5A, the laser etched high friction surface 200 may be a linear pattern that may include grooves 230, or channels, formed in the surface of the end hook 170. The grooves 230 may be etched by moving the laser 210 in straight lines relative to the surface of the rear face 174 in between pulses of the laser 210 such that the laser pulses ablating the surface of the rear face 174 create straight lines that extend across the rear face 174. In other words, the laser 210 may ablate the surface of the end hook 170 with a singular pulse to form a first melt pool from the material of the end hook 170 accordingly. The laser 210 may then move linearly away from the first melt pool, but only enough to reach an edge of the first melt pool. The laser 210 may then generate another pulse to ablate the material of the end hook 170 again, forming a second melt pool. The second melt pool may overlap with the first melt pool, such that there are no raised portions 250 of material between consecutive melt pools. This process may then be repeated to ablate linear grooves 230 into the material of the end hook 170. In some cases, the grooves 230 of the linear pattern may be etched substantially parallel to the blade 140 of the measuring tape device 100. In some other cases, the grooves 230 may be etched substantially perpendicular to the blade 140.

In an example embodiment, such as the one depicted in FIG. 5B, the high friction surface 200 may include a dimple pattern. In the case of the dimple pattern, the laser 210 may ablate a single point to create a crater 240 on the surface of the end hook 170 without moving the laser 210 relative to the end hook 170 while the laser pulses are actively etching the end hook 170. The crater 240 that forms as a result may accordingly be surrounded by a raised section 250. Replicating the crater 240 and the raised section 250 across the surface of the end hook 170 may form the high friction surface 200. In other words, the laser 210 may ablate the surface of the end hook 170 with a singular pulse to form a first melt pool from the material of the end hook 170 accordingly. The laser 210 may then move away from the first melt pool, beyond an edge of the first melt pool. The laser 210 may then generate another pulse to ablate the material of the end hook 170 again, forming a second melt pool. The second melt pool may not overlap with the first melt pool, such that there is a raised portion 250 of material between consecutive melt pools. Therefore, the melt pools may be surrounded by the raised portions 250 on all sides of the melt pools. This process may then be repeated to ablate the craters 240 into the material of the end hook 170. As described above, the depth of the crater 240 may be a function of the intensity of the laser 210, the duration of the pulses, and the number of pulses applied to the particular location.

In some cases, the end hook 170 may include a coating 270 of paint or another soft material applied over the high friction surface 200. In this regard, the laser etched pattern of the high friction surface 200 may have sufficiently large dimensions to accommodate the coating 270 over top thereof without entirely diminishing the coefficient of friction between the end hook 170 and the medium 180. In other words, after the coating 270 is applied to the end hook 170, and thus to the high friction surface 200, the coating may tend to settle on the high friction surface 200 as it dries. In this regard, the grooves 230 or craters 240 of the laser etched patterns may accumulate more of the coating 270 as it dries, and the raised portions 250 may end up with less coating 270 as it dries. The result of this may be a slight reduction in the depth of the grooves 230 or craters 240, and a slight reduction in the height of the raised portions 250. Accordingly, the application of the coating 270 may have a slight adverse effect on the laser etched features of the high friction surface 200. In some embodiments, the coating 270 may be a hydrophobic coating. In an example embodiment, the hydrophobic coating may increase the coefficient of friction between the end hook 170 and the medium 180 by repelling moisture and ensuring a dry operable coupling between the end hook 170 and the anchor point 182. In some other cases, the coating 270 may be an anti-corrosive coating to preserve the high friction surface 200 from being reduced due to corrosion.

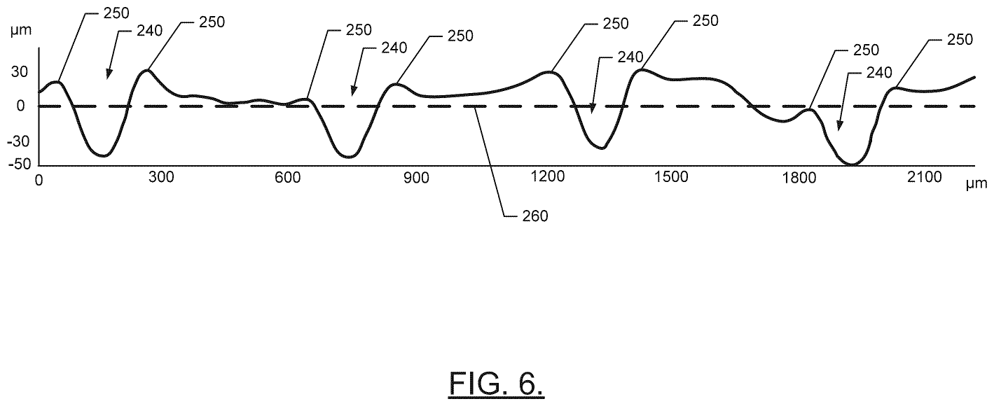

FIG. 6 illustrates a profile view of the high friction surface 200 after the laser etching process. In this regard, the surface of the rear face 174 may include a plurality of craters 240 and a plurality of raised portions 250. In addition to the profile of the laser etched high friction surface 200, the un-etched surface 260 is superimposed on FIG. 6 as well. The un-etched surface 260 may provide some perspective for how, during the ablation process, the material of the end hook 170 may be displaced to the raised portion 250 responsive to the formation of the crater 240. In other words, the ablation process does not just remove material from the crater 240, as shown by the dip in the profile line of FIG. 6, but the ablation process simultaneously adds the material removed from the crater 240 to the raised portions 250, as shown by the profile line in FIG. 6 extending above the un-etched surface 260. In some cases, the depth of the crater 240, measured from the tip of the raised portion 250, may be within the range of 30 to 90 micrometers. In an example embodiment, the crater 240 may be approximately 75 micrometers deep.

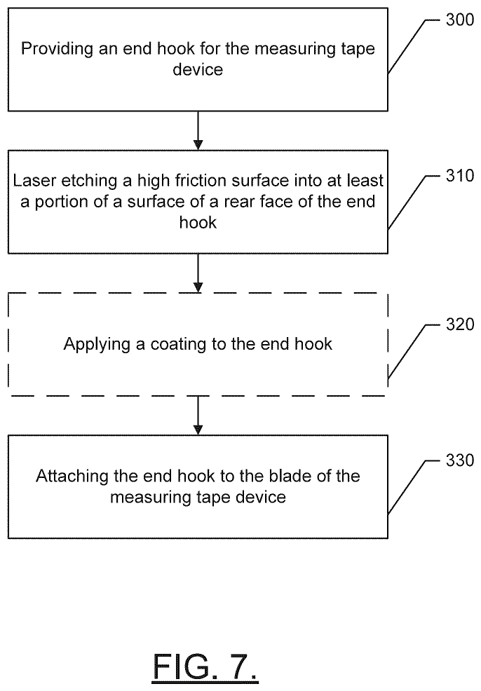

FIG. 7 illustrates a flowchart diagram of a method of making a measuring tape device in accordance with an example embodiment. The method is described in steps 300-330 of FIG. 7. In some embodiments, step 320 may be optional, as indicated by the dashed lines shown in FIG. 7.

Some example embodiments may provide for a measuring tape device. The measuring tape device may include a housing which may have an aperture, a reel assembly, a blade which may have a first end that may extend from the housing through the aperture and a second end wound on the reel assembly, and an end hook which may be disposed at the first end of the blade. The end hook may have a front face that faces away from the aperture and a rear face that faces toward the aperture. A high friction surface comprising laser etching may be disposed over at least a portion of a surface of the rear face.

The measuring tape device of some embodiments may include additional, optional features, and/or the features described above may be modified or augmented. Some examples of modifications, optional features and augmentations are described below. It should be appreciated that the modifications, optional features and augmentations listed below may each be added alone, or they may be added cumulatively in any desirable combination. For example, in some embodiments, the high friction surface may be disposed at substantially all of the surface of the rear face. In some cases, the end hook may further include an upright extension portion that may be planar with the rear face and may extend perpendicular to the blade on an opposite side of the blade from the rear face. In an example embodiment, the high friction surface may be disposed on the upright extension portion of the end hook. In some cases, a width of the end hook may be greater than a width of the blade such that portions of the end hook extend outside the width of the blade to provide an expanded surface area for engagement of at least the rear face with an anchor point. In an example embodiment, the high friction surface may be disposed on the portions of the end hook that extend outside the width of the blade. In some cases, a surface area of the high friction surface may be greater than ½ a surface area of the rear face. In an example embodiment, the high friction surface may include a dimple pattern that may include craters and raised portions. In some cases, the dimple pattern may be formed by ablating the material of the surface of the rear face with a laser. In an example embodiment, the laser may not move relative to the end hook while the laser may be ablating the material of the surface of the rear face to form the craters. In some cases, the high friction surface may include a linear pattern which may include grooves. In an example embodiment, the linear pattern may be formed by ablating the material of the surface of the rear face with a laser. In some cases, the laser may move relative to the end hook while the laser may be ablating the material of the surface of the rear face to form the grooves.

Some example embodiments may provide for an end hook for a measuring tape device. The end hook may include a front face that may face away from an aperture through which a blade of the measuring tape device may be extendible, a rear face that may face toward the aperture, and a high friction surface which may include laser etching disposed over at least a portion of a surface of the rear face.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A measuring tape device comprising:
a housing having an aperture;
a reel assembly;
a blade having a first end configured to extend from the housing through the aperture and a second end configured to be wound on the reel assembly; and
an end hook disposed at the first end of the blade, the end hook having a front face that faces away from the aperture and a rear face that faces toward the aperture,
wherein a high friction surface comprising laser etching is disposed over at least a portion of the end hook.

2. The device of claim 1, wherein the high friction surface is disposed at substantially all of a surface of the rear face.

3. The device of claim 1, wherein the end hook further comprises an upright extension that is planar with the rear face and extends perpendicular to the blade on an opposite side of the blade from the rear face.

4. The device of claim 3, wherein the high friction surface is disposed on the upright extension of the end hook.

5. The device of claim 1, wherein a width of the end hook is greater than a width of the blade such that portions of the end hook extend outside the width of the blade to provide an expanded surface area for engagement of at least the rear face with an anchor point.

6. The device of claim 5, wherein the high friction surface is disposed on the portions of the end hook that extend outside the width of the blade.

7. The device of claim 1, wherein a surface area of the high friction surface is greater than ½ a surface area of the rear face.

8. The device of claim 1, wherein the high friction surface comprises a dimple pattern comprising craters and raised portions.

9. The device of claim 8, wherein the craters of the dimple pattern are consecutive melt pools formed by ablating material of the surface of the rear face with a laser, and
wherein the melt pools are surrounded by the raised portions on all sides.

10. The device of claim 1, wherein the high friction surface comprises a linear pattern comprising grooves.

11. The device of claim 10, wherein the grooves of the linear pattern are consecutive melt pools formed by ablating material of the surface of the rear face with a laser, and
wherein the melt pools are not surrounded by the raised portions in between consecutive melt pools.

12. An end hook for a measuring tape device, the end hook comprising:
a front face that faces away from an aperture through which a blade of the measuring tape device is extendible;
a rear face that faces toward the aperture; and
a high friction surface comprising laser etching disposed over at least a portion of the end hook.

13. The end hook of claim 12, wherein the high friction surface is disposed of substantially all of a surface of the rear face.

14. The end hook of claim 12, wherein the end hook further comprises an upright extension that is planar with the rear face and extends perpendicular to the blade on an opposite side of the blade from the rear face.

15. The end hook of claim 14, wherein the high friction surface is disposed on the upright extension of the end hook.

16. The end hook of claim 12, wherein the high friction surface comprises a dimple pattern comprising craters and raised portions.

17. The end hook of claim 16,
wherein the craters of the dimple pattern are consecutive melt pools formed by ablating material of the surface of the rear face with a laser, and
wherein the melt pools are surrounded by the raised portions on all sides.

18. The end hook of claim 12, wherein a width of the end hook is greater than a width of the blade such that portions of the end hook extend outside the width of the blade to provide an expanded surface area for engagement of at least the rear face with an anchor point.

19. The end hook of claim 18, wherein the high friction surface is disposed on the portions of the end hook that extend outside the width of the blade.

20. A method of making a measuring tape device, the method comprising:
providing the end hook for the measuring tape device;
laser etching a high friction surface into at least a portion of a surface of a rear face of the end hook;
applying a coating to the end hook; and
attaching the end hook to a blade of the measuring tape device.
